(19) United States
(12) Patent Application Publication
(10) Pub. No.: US 2019/0325201 A1
(43) Pub. Date: Oct. 24, 2019

(54) AUTOMATED EMOTION DETECTION AND KEYBOARD SERVICE

(71) Applicant: MICROSOFT TECHNOLOGY LICENSING, LLC, Redmond, WA (US)

(72) Inventors: Rupreet Singh GUJRAL, Hyderabad (IN); Varun Kumar PALAVALASA, Hyderabad (IN); Noor MAHDI, Wellington (NZ)

(21) Appl. No.: 15/957,124

(22) Filed: Apr. 19, 2018

(51) Int. Cl. G06K 9/00; G06F 3/0482; G06F 3/0488

(52) U.S. Cl. CPC G06K 9/00302; H04L 51/046; G06F 3/04886; G06F 3/0482

(57) ABSTRACT

Various embodiments described herein relate to coupling textual and emotional communication in a communication service. One embodiment captures an image from a user of an application. Next, an expression is determined from the image. The application then identifies a graphical expression which corresponds to the graphical expression. Finally, the application displays the graphical expression. This can be done for example via a WI-FI network, a cellular network, or other mode of peer-to-peer or server-based communication scheme. The present invention also provides a keyboard service.

### BACKGROUND

The use of chat applications has increased dramatically. In today's world, communication through chatting applications is one of the most preferred methods of communication. One of the reasons people have gravitated to chat applications is because it provides an instantaneous exchange of information with some of the features of real life communication in real time. However, real life, face to face communication involves many non-verbal cues, such as facial expressions and/or emotional cues that are highly informative to the users. These cues are not present with chat applications.

Also, there are no chat application services that allow for the user to instantly and effectively share their emotions and feelings. The use of emojis has become popular because it is a quick way to share your emotions in a communication session. Users usually select specific emojis which resemble the actual emotion they are feeling and shares it with the other user.

When a user wants to convey a graphical expression, such as an emoji, the user is often required to scroll through many pages of graphical expressions to find relevant expressions. In some devices, there are dozens if not hundreds of graphical expressions, e.g., emojis, for user to choose from. This can be cumbersome and not always lead to a satisfying result.

Therefore, there is a need for improved communication application that can address these issues. It is with respect to these and other considerations that the disclosure made herein is presented.

### SUMMARY

The present invention is direction toward techniques for automating aspects of the communication of expressions between two or more computing devices. Embodiments of the present disclosure analyzes the facial expressions of a user and/or other contextual information regarding the communication session and recommends relevant expressions to a user. This helps the user by enabling a computer to display a reduced set of expressions, e.g., emotions, instead of displaying a large number of expressions. Such features help improve a user's interaction with a computer, in that they don't have irrelevant emojis cluttering the screen, thereby saving them time and effort. In other embodiments, some expressions are automatically communicated to remote users, thereby also reducing the need to display irrelevant emojis or other expressions.

The graphical expressions may be conveyed using a variety of different emotions. But when a user shows an expression to a camera or other sensor of a computer, a computer can display a targeted set of emotions for a user to select. For instance, if the user is smiling, the computing device will only recommend graphical expressions that are consistent with a happy emotional state. Likewise, when the user is frowning, emojis only showing a sad emotional state will be displayed.

In some embodiments of the present invention, a computer captures an image using a camera or other type of sensor. For example, a user might be using a cell phone with a front-facing camera and running a chat application. The chat application would instruct the camera to capture the image of the user.

Next, an expression is determined from the image. Image data can be analyzed to determine one or more facial features and determine an emotion or expression. The chat application might have access to an emotion detection module, which can analyze the image and return a match for one of a plurality of known human emotions. For example, a user running the chat application might smile. The chat application, in response, would receive a response from the emotion detection module that it had in fact matched the image to the expressed state of happiness.

Next, the application identifies a graphical expression from a list of one or more graphical expressions. When the application determines that an indication of an expression is made (e.g., happiness, sadness, confusion, frustration, and the like) by the user, the application might, for example, access a data structure in memory which associates each of the possible identified emotions with a single graphical expression. Other graphical expressions can be filtered from display and only relevant graphical expressions are displayed to the user for selection, as shown above.

Alternatively, rather than sending a graphical expression, one embodiment sends an emotion notification based on the user's emotional state. The emotion notification can be textual or graphical in nature, but otherwise notifies other user of the user's currently detected emotional state. Selecting an emotion notification can proceed, in one embodiment, in a manner analogous to selecting a graphical expression. From the data structure, it can find the right graphical expression or emotion notification and provide it to the chat application.

Next, the application displays the graphical expression or emotion notification. The chat application, as an example, draws a picture of the single graphical expression it identified earlier on the display screen of the phone. Finally, the chat application sends the graphical expression or emotion notification to the other user. This can be done for example via a wi-fi network, a cellular network, or other mode of peer-to-peer or server-based communication scheme.

In another embodiment, a system receives one or more streams associated with a communication session, the one or more streams comprising image data of a user participating in the communication session. Next, the system analyzes at least one physical feature of the user to determine a category of graphical expressions or emotion notifications. For example, the server might have access to an emotion detection module, which can analyze the image and return a match for one of a plurality of known human emotions. The server receives a response from the emotion detection module that it had, in fact, matched the image to an expressed state looking at least one physical feature in the data.

Next, the system selects a graphical expression or emotion notification from a plurality of graphical expressions or emotion notifications, wherein the selection of the graphical expression or emotion notification is based on the category of graphical expressions or emotion notifications. Thereafter, the system causes a display of a graphical user interface on a client computing device associated with one or more users in communication with the user, wherein the graphical user interface includes a rendering of the graphical expression or the emotion notification. The server, as an example, sends image data across a network to a device such as the phone. The image data has the information the phone needs, that when the phone receives the data via the network, it causes it to draw a picture of the single graphical expression or emotion notification the server identified earlier. In the case of the emotion notification, the system merely updates the user with the appropriate notification.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of an example of a communication system.

FIG. 2 is a block diagram of an example of the device in the communication system of FIG. 1.

FIG. 3 is an example of image data which is used in the system of FIG. 1.

FIG. 4A is a block diagram which illustrates an example according to an embodiment of the present invention, where the user has selected the manual mode of operation of the keyboard service.

FIG. 4B is a block diagram which illustrates an example according to an embodiment of the present invention where the user has selected the manual mode of operation of the keyboard service.

FIG. 4C is a block diagram which illustrates an example according to an embodiment of the present invention where the user has selected the manual mode of operation of the keyboard service.

FIG. 5A is a block diagram which illustrates an example according to an embodiment of the present invention where the user has selected the automated mode of operation of the keyboard service.

FIG. 5B is a block diagram which illustrates an example according to an embodiment of the present invention where the user has selected the automated mode of operation of the keyboard service.

FIG. 5C is a block diagram which illustrates an example according to an embodiment of the present invention where the user has selected the automated mode of operation of the keyboard service.

FIG. 6 is a flowchart illustrating an operation of a communication session according to an embodiment involving a client.

FIG. 7 is a flowchart illustrating an operation of a communication session according to an embodiment involving a server.

FIG. 8 is a flowchart illustrating an operation of a communication session according to an embodiment involving an emotion notification.

### DETAILED DESCRIPTION

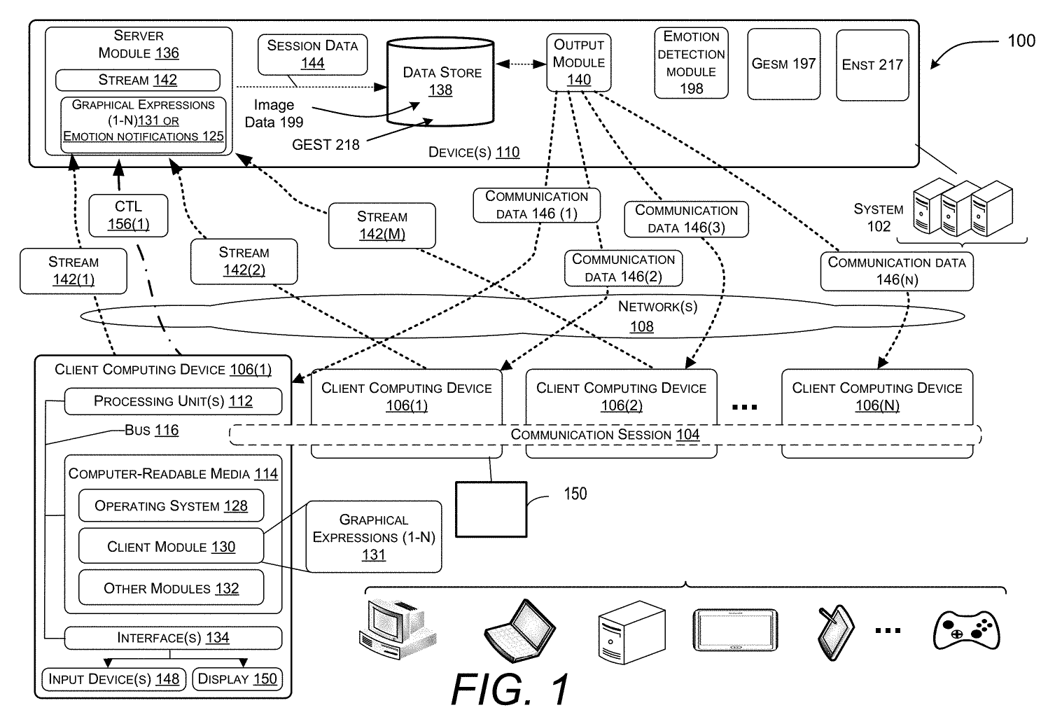

Examples described below enable a system to provide for coupling textual and emotional communication in a communication system. In FIG. 1, a diagram illustrating an example of a communication system 100 is shown in which a system 102 can provide an indication of graphical expressions 131(1-N) with views for a communication session 104 in accordance with an example implementation. In this example, the communication session 104 is between a number of client computing devices 106(1) through 106(N) (where N is a positive integer number having a value of two or greater). The client computing devices 106(1) through 106(N) enable users to participate in the communication session 104.

In this example, the communication session 104 may be hosted, over one or more network(s) 108, by the system 102. That is, the system 102 may provide a service that enables users of the client computing devices 106(1) through 106(N) to participate in the communication session 104. As an alternative, the communication session 104 may be hosted by one of the client computing devices 106(1) through 106(N) utilizing peer-to-peer technologies.

The system 102 includes device(s) 110, and the device(s) 110 and/or other components of the system 102 may include distributed computing resources that communicate with one another, with the system 102, and/or with the client computing devices 106(1) through 106(N) via the one or more network(s) 108. In some examples, the system 102 may be an independent system that is tasked with managing aspects of one or more communication sessions 104.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Example networks support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, mobile phones, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a communication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. In some implementations, a client computing device includes input/output (“I/O”) interfaces that enable communications with input/output devices such as user input devices including peripheral input devices (e.g., a game controller, a keyboard, a mouse, a pen, a voice input device, a touch input device, a gestural input device, and the like) and/or output devices including peripheral output devices (e.g., a display, a printer, audio speakers, a haptic output device, and the like).

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses. The computer-readable media 114 may store executable instructions and data used by programmed functions during operation. Examples of functions implemented by executable instructions stored on the computer-readable media 114 may include, for example, an operating system 128, a client module 130, other modules 132, and, programs or applications that are loadable and executable by processing units(s) 112.

Client computing device(s) 106(1) through 106(N) may also include one or more interface(s) 134 to enable communications with other input devices 148 such as network interfaces, cameras, keyboards, touch screens, and pointing devices (mouse). For example, the interface(s) 134 enable communications between client computing device(s) 106(1) through 106(N) and other networked devices, such as device(s) 110 and/or devices of the system 102, over network(s) 108. Such network interface(s) 134 may include one or more network interface controllers (NICs) or other types of transceiver devices to send and receive communications and/or data over a network.

In the example environment 100 of FIG. 1, client computing devices 106(1) through 106(N) may use their respective client modules 130 to connect with one another and/or other external device(s) in order to participate in the communication session 104. For instance, a first user may utilize a client computing device 106(1) to communicate with a second user of another client computing device 106(2). When executing client modules 130, the users may share data, which may cause the client computing device 106(1) to connect to the system 102 with the other client computing devices 106(2) through 106(N) over the network(s) 108.

The client module 130 of each client computing device 106(1) through 106(N) may include logic that detects user input and communicates control signals to the server relating to controlling aspects of the communication session 104. For example, the client module 130 in the first client computing device 106(1) in FIG. 1 may detect a user input at an input device 148. The user input may be sensed, for example, as a finger press on a user interface element displayed on a touchscreen, or as a click of a mouse on a user interface element selected by a pointer on the display 150. The client module 130 translates the user input according to a function associated with the selected user interface element.

As discussed above, one or more streams from client computing devices 106 in environment 100 comprise image data 199 of a user participating in the communication session 104. The client module 130 may send a control signal 156(1) (also referred to herein as a “control command” or an “indication”) to a server (for example, a server operating on the device 110) to perform the desired function.

In some examples, the system 102 generates communication data 146 that includes graphical expressions. In the examples disclosed herein, the client computing devices 106 (1) through 106(N) can communicate and display one or more graphical expressions 131(1-N). Graphical expressions 131(1-N) can be, for example, an emoticon. The graphical expression is associated with an emotion of a user of one of the client computing devices 106(1) through 106(N). The graphical expression 131(1-N) is detected by an emotion detection module 198 using an image of the user where the image is stored as image data 199. The image data 199 was received during the communication session 104 between two or more of the users of client computing devices 106(1) through 106(N).

The system 102 may receive one or more streams associated with a communication session 104; the one or more streams comprising image data 199 of a user participating in the communication session 104, and begin analyzing at least one physical feature of the user using an emotion detection module 198 to determine one or more of the graphical expressions 131(1-N). Next, the system 102 selects one of the plurality of graphical expressions 131(1-N) using a graphical expression selection module (GESM) 197.

Finally, the server 102 causes a display of a graphical user interface on one or more of the client computing devices 106(1-N) using a display interface module 196, wherein the graphical user interface includes a rendering of the graphical expression 131(1-N). For example, if there are two or more users of client computing devices 106(1-N) and the user of one of the client computing devices 106(1-N) was in communication with another user with a client computing device 106(1-N) while using a chat application and then read something that made them happy, then the GESM 197 can detect the emotion in image data 199 from the user who was happy, and in response send a graphical expression 131(1-N) associated with happiness to the other user in the communication session 104, by accessing and selecting from a graphical expression selection table (GEST) 218.

In other embodiments, an emotion notification 125 is sent instead of a graphical expression 131(1-N). In this embodiment, the server 102 causes a display of a graphical user interface on one or more of the client computing devices 106(1-N) using a display interface module 196, wherein the graphical user interface includes a rendering of the graphical expression 131(1-N). For example, if there are two or more users of client computing devices 106(1-N) and the user of one of the client computing devices 106(1-N) was in communication with another user with a client computing device 106(1-N) while using a chat application and then read something that made them happy, then the GESM 197 can detect the emotion in image data 199 from the user who was happy, and in response send an emotion notification 125 associated with happiness to the other user in the communication session 104, by accessing and selecting from an emotion notification selection table (ENST) 217.

As shown in FIG. 1, the device(s) 110 of the system 102 includes a server module 136, a data store 138, and an output module 140. The server module 136 is configured to receive, from individual client computing devices 106(1) through 106(N), streams 142(1) through 142(M) (where M is a positive integer number equal to 2 or greater). In some scenarios, not all the client computing devices utilized to participate in the communication session 104 provide an instance of streams 142, and thus, M (the number of instances submitted) may not be equal to N (the number of client computing devices). In some other scenarios, one or more of the client computing devices 106 may be communicating an additional stream 142 that includes content, such as a document or other similar type of media intended to be shared during the communication session 104.

The server module 136 is also configured to receive, generate and communicate session data 144 and to store the session data 144 in the data store 138. The session data 144 can define aspects of a communication session 104, such as the identities of the participants, the content that is shared, etc. In various examples, the server module 136 may select aspects of the streams 142 that are to be shared with the client computing devices 106(1) through 106(N). The server module 136 may combine the streams 142 to generate communication data 146 defining aspects of the communication session 104. The communication data 146 can comprise individual streams containing select streams 142. The communication data 146 can define aspects of the communication session 104, such as a user interface arrangement of the user interfaces on the client computing devices 106, the type of data that is displayed and other functions of the server module 136 and client computing devices. The server module 136 may configure the communication data 146 for the individual client computing devices 106(1)-106(N). Communication data can be divided into individual instances referenced as 146(1)-146(N). The output module 140 may communicate the communication data instances 146(1)-146(N) to the client computing devices 106(1) through 106(N). Specifically, in this example, the output module 140 communicates communication data instance 146(1) to client computing device 106(1), communication data instance 146(2) to client computing device 106(2), communication data instance 146(3) to client computing device 106(3), and communication data instance 146(N) to client computing device 106(N), respectively.

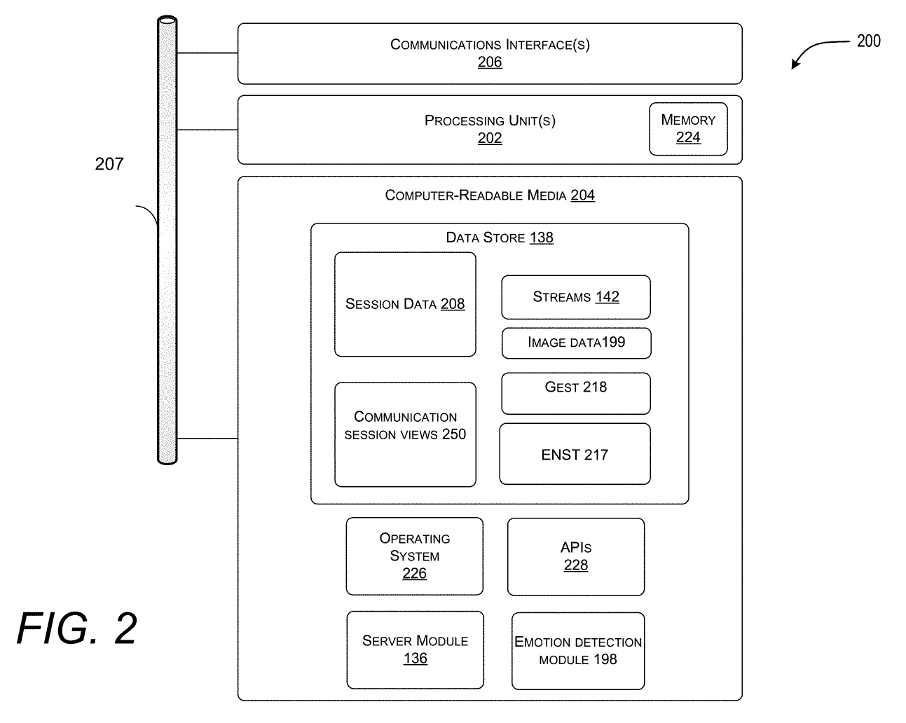

The communication data instances 146(1)-146(N) may communicate audio that may include video representative of the contribution of each participant in the communication session 104. Each communication data instance 146(1)-146(N) may also be configured in a manner that is unique to the needs of each participant user of the client computing devices 106(1) through 106(N). Each client computing device 106(1) through 106(N) may be associated with a communication session view. Examples of the use of communication session views to control the views for each user at the client computing devices 106 are described with reference to FIG. 2.

In FIG. 2, a system block diagram is shown illustrating components of an example device 200 configured to provide the communication session 104 between the client computing devices, such as client computing devices 106(1) through 106(N) in accordance with an example implementation. The device 200 may represent one of device(s) 110 where the device 200 includes one or more processing unit(s) 202, computer-readable media 204, and communication interface(s) 206. The components of the device 200 are operatively connected, for example, via a bus 207, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communications media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network. The communication interfaces 206 are used to facilitate communication over a data network with client computing devices 106.

In the illustrated example, computer-readable media 204 includes the data store 138. In some examples, the data store 138 includes data storage such as a database, data warehouse, or other type of structured or unstructured data storage. In some examples, the data store 138 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 138 may store data for the operations of processes, applications, components, and/or modules stored in computer-readable media 204 and/or executed by processing unit(s) 202 and/or accelerator(s). For instance, in some examples, the data store 138 may store session data 208 (e.g., session data 144), profile data 210, and/or other data. The session data 208 may include a total number of participants in the communication session 104, and activity that occurs in the communication session 104 (e.g., behavior, activity of the participants), and/or other data related to when and how the communication session 104 is conducted or hosted. Examples of profile data 210 include, but are not limited to, a participant identity (“ID”) and other data.

In an example implementation, the data store 138 stores data related emotions that each user expresses during a communication session 104. These expressions are matched to associated graphical expressions 131 (1-N) for display of another of the users' client computing devices 106 (1-N).

The system 102 generates communication data 146 that when displayed by the display of client computing device 106 (2), allows the client computing device 106(2) to display one of the graphical expression 131 (1-N) that is associated with an emotion of the first user, where the emotion is detected in an image of the first user that is in communication with the client computing device 106(1), thereby displaying the graphical expression 131 (1-N) on the client computing device 106(2) of the second user.

Alternately, some or all of the above-referenced data can be stored on separate memories 224 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes an operating system 226 and an application programming interface(s) 228 configured to expose the functionality and the data of the device(s) 110 (e.g., example device 200) to external devices associated with the client computing devices 106(1) through 106(N). Additionally, the computer-readable media 204 includes one or more modules such as the server module 136 and an output module 140, although the number of illustrated modules is just an example, and the number may vary higher or lower. That is, functionality described herein in association with the illustrated modules may be performed by a fewer number of modules or a larger number of modules on one device or spread across multiple devices.

As such and as described earlier, in general, the system 102 is configured to host the communication session 104 with the plurality of client computing devices 106(1) through 106(N). The system 102 includes one or more processing units 202 and a computer-readable medium 204 having encoded thereon computer-executable instructions to cause the one or more processing units 202 to receive streams 142(1) through 142(M) at the system 102 from a plurality of client computing devices 106(1) through 106(N), select streams 142 based, at least in part, on the communication session view 250 for each user, and communicate communication data 146 defining the communication session views 250 corresponding to the client computing devices 106(1) through 106(N).

The communication data instances 146(1) through 146(N) are communicated from the system 102 to the plurality of client computing devices 106(1) through 106(N). The communication session views 250(1) through 250(N) cause the plurality of client computing devices 106(1) through 106(N) to display views of the communication session 104 under user control. The computer-executable instructions also cause the one or more processing units 202 to determine that the communication session 104 is to transition to a different communication session view of the communication session 104 based on a user communicated control signal 156.

It is noted that the above description of the hosting of a communication session 104 by the system 102 implements the control of the communication session view in a server function of the device 110. In some implementations, the server function of the device 110 may combine all media portions into the communication data 146 for each client computing device 106 to configure the view to display. The information stored in the communication session view as described above may also be stored in a data store 138 of the client computing device 106. The client computing device 106 may receive a user input and translate the user input as being a view switching control signal that is not transmitted to the server. The control signal may be processed on the client computing device itself to cause the display to switch to the desired view. The client computing device 106 may change the display by re-organizing the portions of the communication data 146 received from the server according to the view selected by the user.

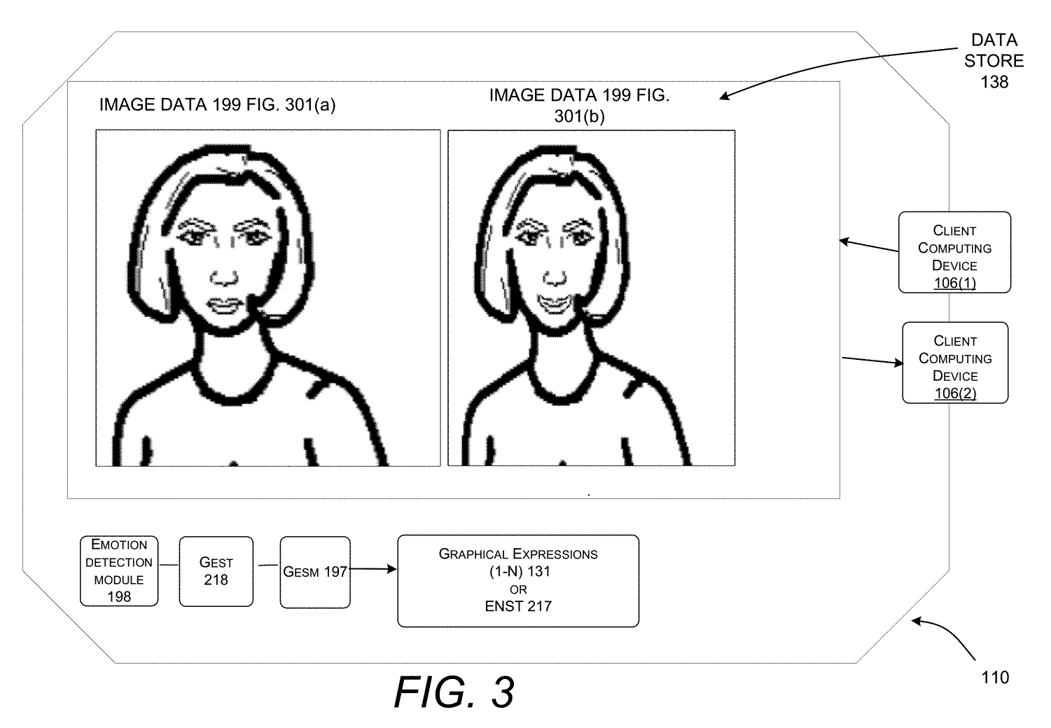

The ability for users participating in a communication session 104 to view graphical expressions 131(1-N) as well as other content relating to the communication session 104 is described with reference to screenshots of the display. The user's image may be analyzed to determine an emotion using pattern recognition or other suitable technology. Reference is made to FIG. 3, which illustrates an example of image data that can be used by the system to determine an emotion. The facial expressions can be used to identify an indication of a change in expression.

For instance, a first user may utilize a client computing device 106(1) to communicate with a second user of another client computing device 106(2). Specifically, FIG. 3 depicts a user participating in a communication session 104. FIG. 3 depicts image data 199 from a client computing device 106(1-N). Image data 199 captured in 301(a) shows the user in a communication session 104 displaying a facial expression which is neutral in nature, as determined by the GESM 197. If during the course of the communication session 104, there was a change in graphical expression 131(1-N), as determined by the GESM 197, such that the user's facial expression changed to a smiling expression as depicted in 301(b), the GESM 197 can detect the emotion in image data 199 from the user who was happy, and in response send a graphical expression 131(1-N) associated with happiness to the other user in the communication session 104, by accessing and selecting from a graphical expression selection table (GEST) 218.

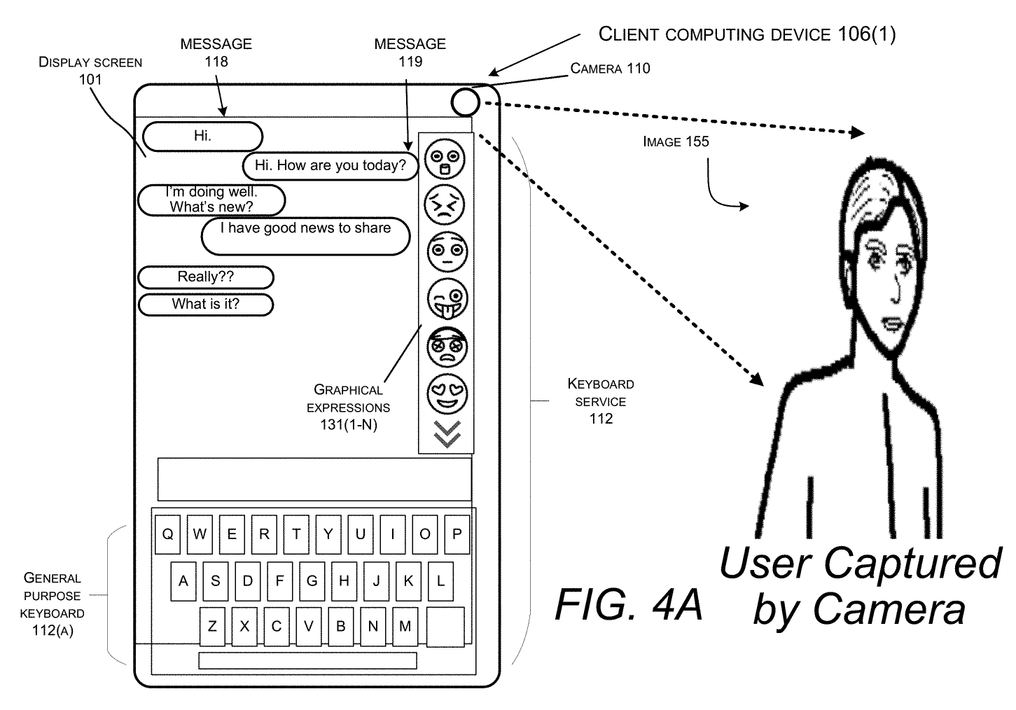

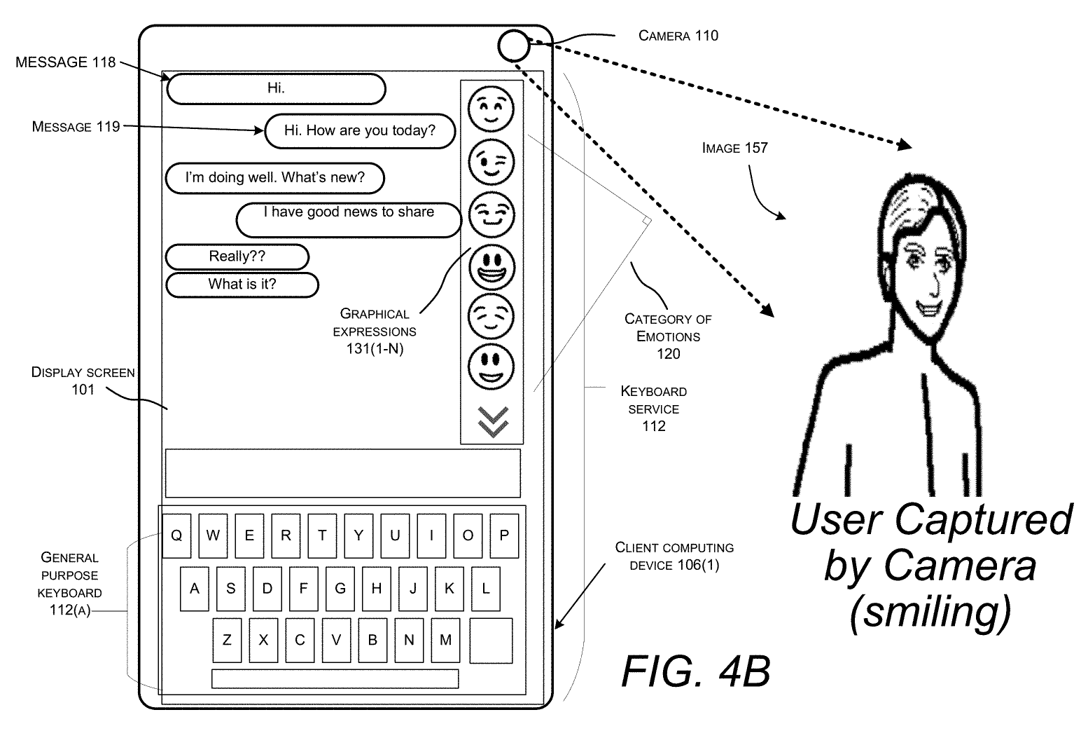

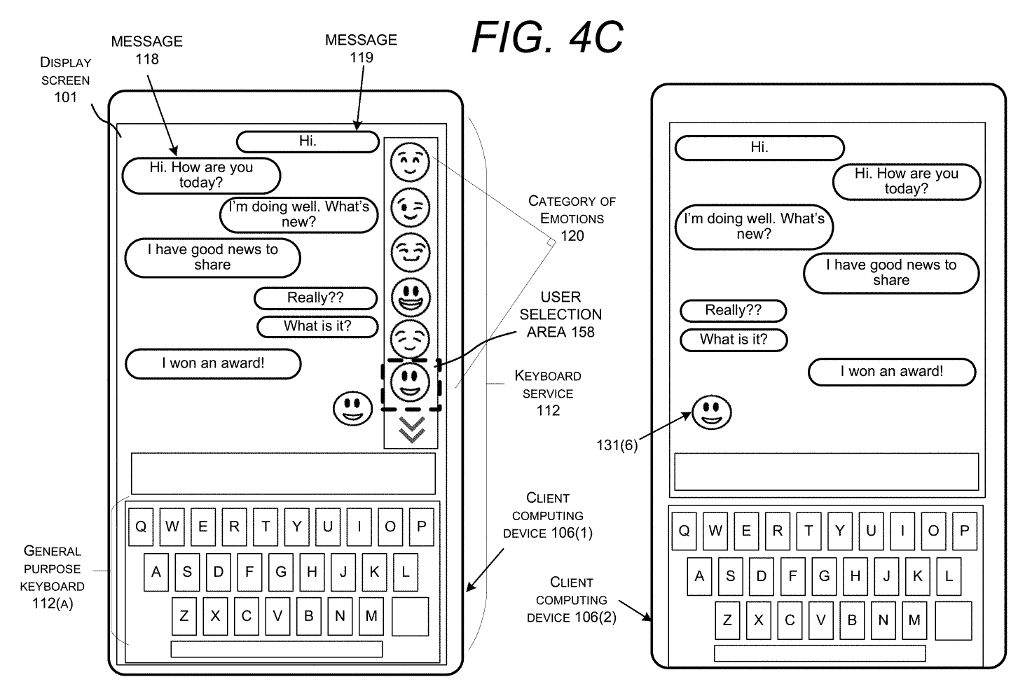

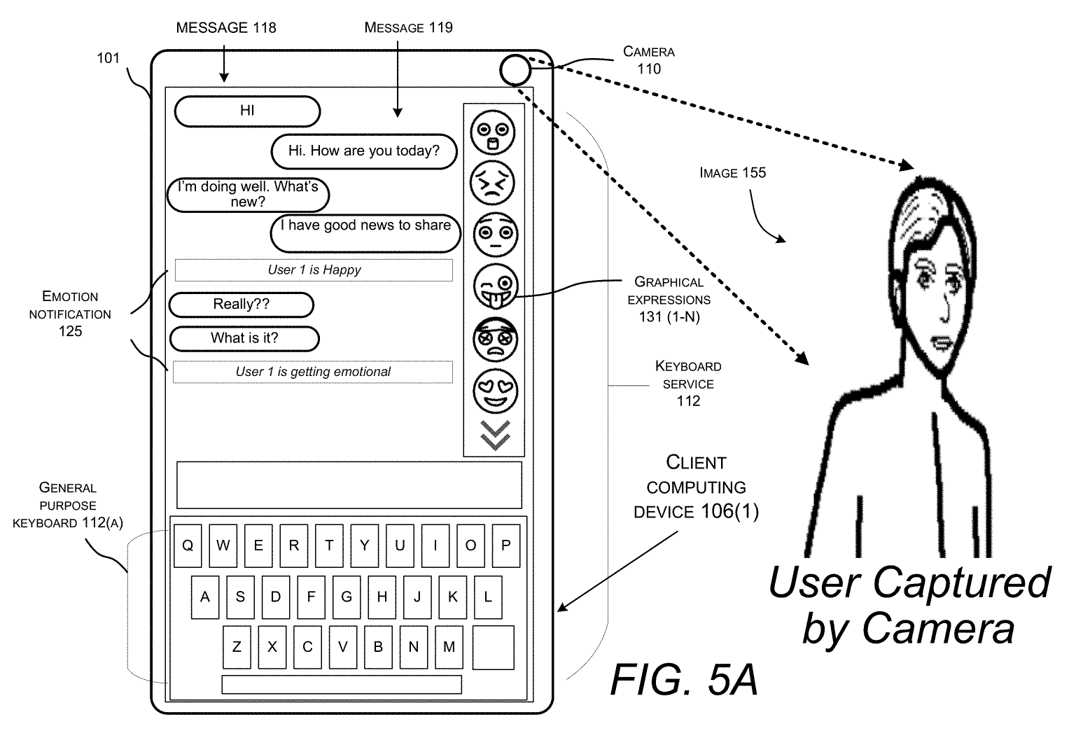

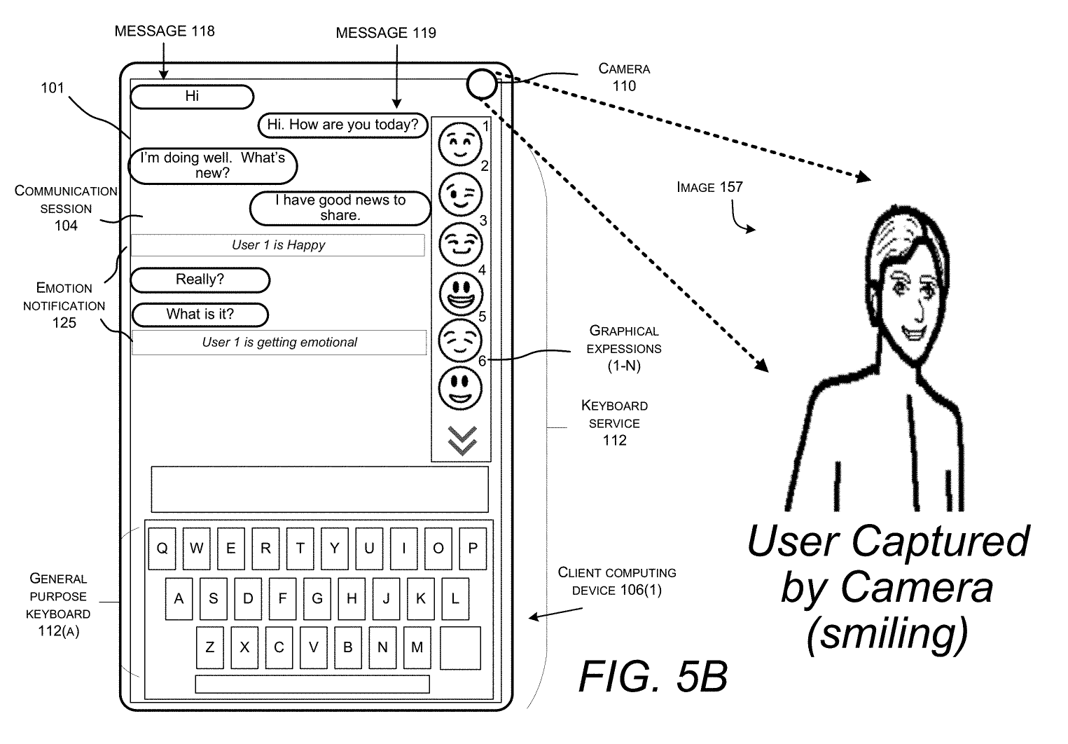

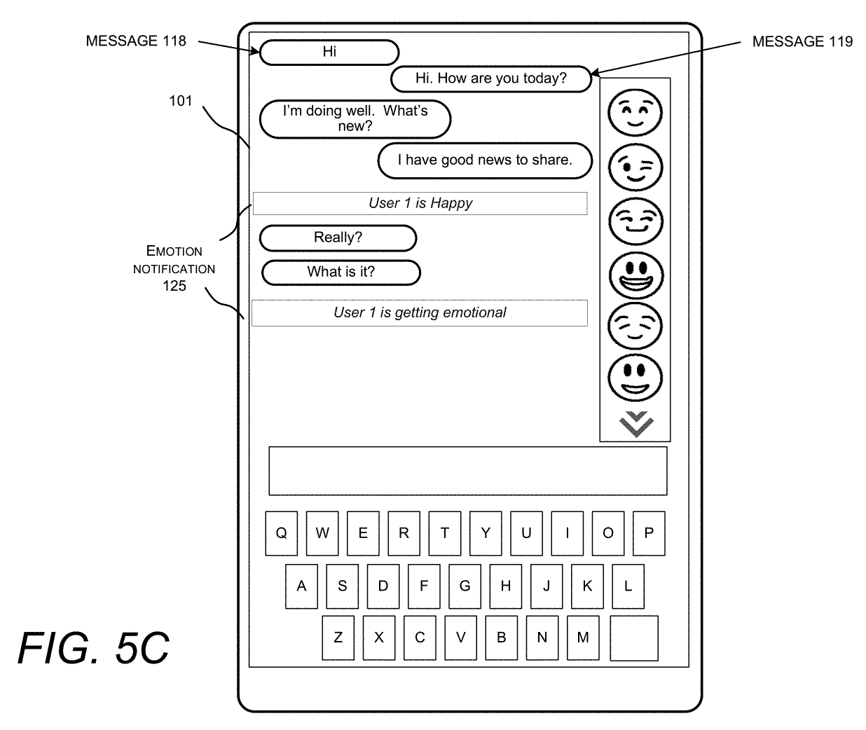

Turning now to FIGS. 4A-5C, these diagrams illustrate first and second operational modes of the invention described herein, although one or more other modes are possible as well. The first mode allows for the user to make a manual selection of one or more of the graphical expressions 131 (1-N). The second mode is automated based on the category of emotions 120 that are detected by the emotion detection module 198. In the first mode, the user can select one of the graphical expressions 131 (1-N) in a user selection area 158, for instance, on the client computing device 106(1-N) or it can be a function on a keyboard service 112.

The keyboard service 112 enhances and is provided by an embodiment of the invention during the communication session 104. The keyboard service 112 can be native or part of the same computer program or chat application installed on the user's client computing device 106(1-N). Alternatively, the keyboard service 112 can be separate. For example, the chat application may be WhatsApp, whereas, the keyboard service is a component of operating system of the device (Android, IOS, or the like), similarly the chat application could be iMessage and the keyboard service 112 would be natively installed and communicates with the operating system.

FIG. 4A is a block diagram used to illustrate an example according to an embodiment of the present invention operates, or where the user has selected the first mode. FIG. 4A shows a communication session 104 between a first user of client computing device 106 (1) and a second user of client computing device 106(2). As an example, the first user of client computing device 106(1) has sent a message 118 to the second user of client computing device 106(2). As such, the display screen 101 of the client computing device 106(1) illustrates the user engaged in the communication session 104 discussed earlier. It shows an example of the communication session 104 which includes a series of messages that are sent between the client computing devices 106(1) and 106(2). The camera 110 of the client computing device 106(1) of the first user captures an image 155 of the first user during the communication session 104.

Continuing with the aforementioned example, FIG. 4B is a block diagram used to illustrate an example according to an embodiment of the present invention. One embodiment of the keyboard service 112 provides a general purpose keyboard 112(a) which can be set in English or any language the user desires, and a general set of graphical expressions 131(1-N) for the user to select during the communication session 104. FIG. 4B takes place at a later time than in FIG. 4A, but in the same communication session 104. Here, the first user of client computing device 106(1) has sent a message 118 to the second user of client computing device 106(2). The second user has replied with a message 119 to the first user and it appears on display screen 101. Subsequently, the first user's expression has changed. The first user is now smiling. When the first user smiles, the camera 110 of the client computing device 106(1) captures the image 157 and sends it to the server module 136 which transforms it into image data 199.

Next, the emotion detection module 198 (e.g. the emotion detection module 198 can utilize Microsoft Emotion Detection API for Microsoft Windows, for example) analyzes the image data 199 to determine if an emotion is detected. The emotion detection module 198 can receive a confidence score across a set of emotions for each face in the image. In one example, the emotion detection module 198 can detect anger, contempt, disgust, fear, happiness, neutral, sadness, and surprise. These are some of the core, universally understood human emotions, although more are possible.

If the emotion detection module 198 detects an emotion, the GESM 197 accesses the GEST 218. The GEST 218 selects one or more of the graphical expressions 131(1-N) that are associated with the detected emotion from the GEST 218. Next, that information is sent to the keyboard service 112 which populates a group of graphical expressions 131(1-N) based on the category of emotion 120 detected. Other graphical expressions can be filtered from display and only relevant graphical expressions are displayed to the user for selection (e.g. if the user is smiling, the computing device will only recommend graphical expressions that are consistent with the user's physical expression. When the user is smiling, emojis only showing smiling expressions will be displayed. When the user is frowning, emojis only showing frowning expressions will be displayed. It will be apparent to one having ordinary skill in the art that there is a category of emotion 120 and associated graphical expressions 131(1-N) that are linked to each of the possible detected emotions.

Next, as shown in FIG. 4C, is a block diagram that illustrates the user can select one of the displayed expressions for delivery to one or more recipients. It illustrates the first user of client computing device 160(1) is making a user selection 158 from one of the category of emotions 120, specifically, a graphical expression 131(6) displayed on the client computing device 106(1) and sends it to the second user of the communication session 104 such that the user selection 158, i.e. graphical expression 131(6) is subsequently displayed as the selected graphical expression 131(6) on the second user's display screen 101 of the second user's client computing device 106(2).

FIGS. 5A-5C are block diagrams that illustrate an example of an embodiment of the invention described herein where the user has turned on the automated operation mode of the keyboard service 112. In this embodiment, the system analyzes the image data and identifies an emotion, based on the physical expression of the user. The detected emotion is sent as a text notification based on the identified physical expression of the user to another remote computing device. This invention also includes an embodiment where the techniques described above are applied to any application running on a computing device. Thus, the techniques described above can be embodied in a keyboard plug-in, thus allowing any applications running on a computing device to receive automated inputs and filtered expressions as described above.

Similar to the manual operation mode, there is a general-purpose keyboard 112(A), along with a general set of graphical expressions 131(1-N). However, unlike the manual operation mode, in the automated operation mode, once an emotion is detected, an emotion notification 125 is automatically generated to the other user.

As shown in FIG. 5A, the camera can detect one or more facial features of the user. FIG. 5A shows a communication session 104 between a first user of client computing device 106 (1) and a second user of client computing device 106(2). As an example, the first user of client computing device 106(1) has sent a message 118 to the second user of client computing device 106(2). As such, the display screen 101 of the client computing device 106(1) illustrates the user engaged in the communication session 104 discussed earlier. It shows an example of the communication session 104 which includes a series of messages that are sent between the client computing devices 106(1) and 106(2). The camera 110 of the client computing device 106(1) of the first user captures an image 155 of the first user during the communication session 104.

Next, FIG. 5B is a block diagram used to illustrate an example according to an embodiment of the present invention. One embodiment of the keyboard service 112 provides a general-purpose keyboard 112(A) which can be set in English or any language the user desires, and a general set of graphical expressions 131(1-N). The communication session 104 illustrated in FIG. 5B takes place at a later time than the communication session 104 in FIG. 5A. Here, the first user of client computing device 106(1) has sent a message 118 to the second user of client computing device 106(2). The second user has replied with a message 119 to the first user and it appears on display screen 101. Subsequently, the first user's expression has changed. The first user is now smiling. When the first user smiles, the camera 110 of the client computing device (1) captures the image 157 and sends it to the server which transforms it into image data 199.

Next, the emotion detection module 198 (e.g. the emotion detection module 198 can use Microsoft Emotion Detection API for Microsoft Windows) analyzes the image data 199 to determine if an emotion is detected. In this example, the emotion detection module 198 takes an image 157 as an input, the image having a facial expression thereupon, and can utilize a confidence threshold across a set of emotions for each face in the image. In one example, the emotions detected by the emotion detection module 198 are anger, contempt, disgust, fear, happiness, neutral, sadness, and surprise. These emotions are understood to be cross-culturally and universally communicated with particular facial expressions, although other expressions are possible. In this example, the emotion detection module 198 has detected happiness.

FIG. 5C shows the display screen 101 on client computing device 106(2). In response to detecting one or more facial features indicating a physical expression, such as a smile, the computing device can auto generate a text notification in the chatting area indicating the emotion of the user. In some cases, as shown in FIG. 5C, the computing device may automatically send the text notification to one or more recipients. In this example, the user's computing device has sent the emotion notification 125 stating “User is Happy” in the chatting area. The second user receives the emotion text “User is Happy” which is displayed on display screen 101. As a result, the user of client computing device 106(2) is automatically updated on the current emotion of the user of client computing device 106(1) despite the user of client computing device 106(1) not having to make an affirmative selection in order to send the emotion notification 125 to the user of client computing device 106(2). As such, in automated mode, the emotion notifications 125 between users during a communication session 104 are automatically sent between users of client computing devices 106 (1-N).

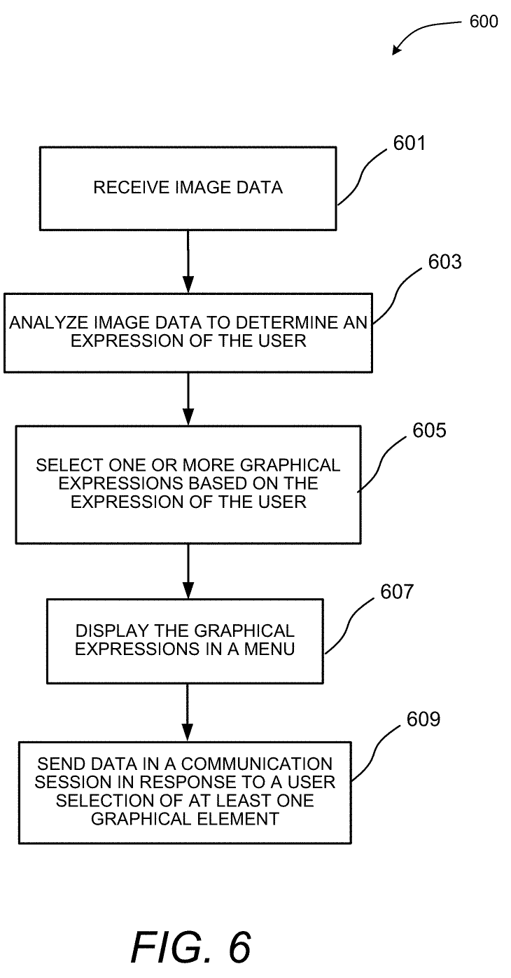

Now turning to FIG. 6, this is a flowchart illustrating an operation of a communication session 104 according to an embodiment of the present invention. At step 601, the system receives image data. For example, it can be captured by the user's cell phone having a front-facing camera. At step 603, the system analyzes image data to determine an expression of the user. For example, the system could send the data to a server or it could locally analyze the data to understand the expression contained therein. One example is Microsoft Face API or Emotion detection APIs.

At step 605, the system selects one or more graphical expressions based on the expression of the user. For example, if the user is happy the system will select from a group of emoticons associated with the sentiment of happiness. Likewise, if the user is surprised, the system will select from a group of emoticons associated with being surprised. At step 607, the system displays the graphical expressions in a menu. For example, the group of emoticons selected in the previous step are shown on a specific portion on the screen which allows user selection of one of the emoticons. At step 609, the system sends data in a communication session in response to a user selection of at least one graphical element. For example, after the user makes a selection of one of the emoticons from the menu, the system sends the selected emoticon via a network to a second user that is in communication with the user that selected the emoticon.

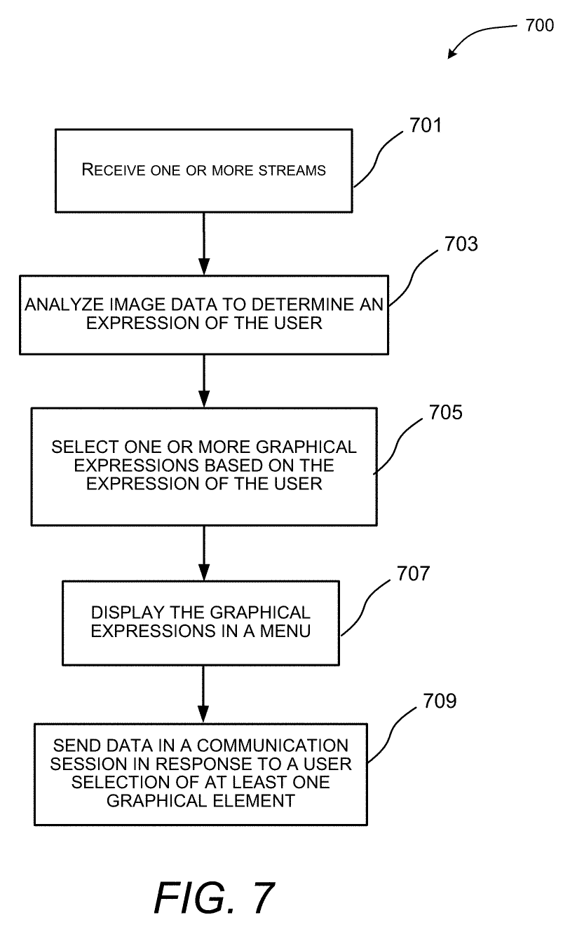

Turning now to FIG. 7, this is a flowchart illustrating an operation of a communication session 104 according to an embodiment of the present invention. At step 701, the system receives one or more streams associated with a communication session, the one or more streams comprising image data of a user participating in a communication session. At step 703, the system analyzes at least one physical feature of the user to determine a category of expressions. At step 705, the system provides a first input area a plurality of graphical expressions from, based on the category of expressions. See for example in FIG. 4B where it shows this type of input area pre-filtered to correspond to the user's identified emotion.

At step 707, the system determines when a selection of one of the plurality of graphical expressions has occurred in the first input area. See for example, FIG. 4C where it shows a user selection area corresponding to the user selecting one of the group of emoticons shown in the input area similar to the one described in step 707.

At step 709, the system causes a display to render the selected one of the plurality of graphical expressions, the display being on the client computing device associated with one or more users in communication with the user.

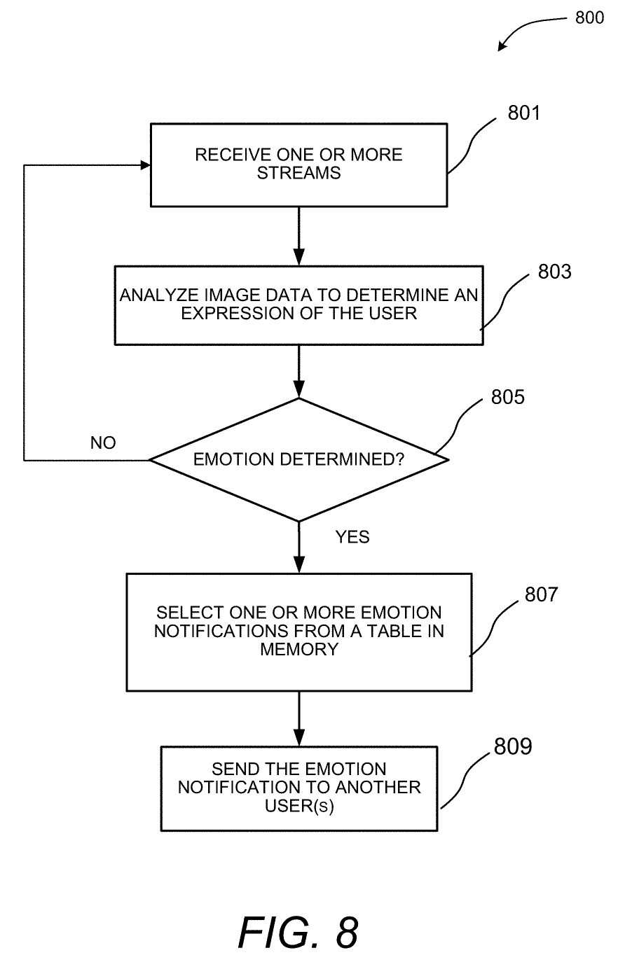

Now turning to FIG. 8, this is a flowchart illustrating an operation of a system 800 that is implementing a communication session 104 according to an embodiment of the present invention. At step 801, the system 800 receives one or more streams associated with a communication session, the one or more streams comprising image data of a user participating in a communication session. At step 803, the system 800 analyzes at least one physical feature of the user to determine an expression of the user.

During step 805, the system 800 analyzes the detected expression to determine whether or not it can detect an emotion. If an emotion was not detected, the system 800 reverts to step 801 and the process repeats. If an emotion is detected at step 805, the system 800 proceeds to step 807 where it selects one or more emotion notifications from a table in memory. Next, at step 809, the system 800 sends the selected emotion notification(s) to another user's computing device.

It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof.

For example, the operations of the routines 600, 700 and/or 800 are described herein as being implemented, at least in part, by an application, component and/or circuit, such as the server module 136 in device 110 in FIG. 1 in the system 100 hosting the communication session 104. In some configurations, the server module 136 can be a dynamically linked library (DLL), a statically linked library, functionality produced by an application programming interface (API), a compiled program, an interpreted program, a script or any other executable set of instructions. Data and/or modules, such as the server module 136, can be stored in a data structure in one or more memory components. Data can be retrieved from the data structure by addressing links or references to the data structure.

Although the following illustration refers to the components of FIG. 1 and FIG. 2, it can be appreciated that the operations of the routines 600, 700 and/or 800 may also be implemented in many other ways. For example, the routines 600, 700 and/or 800 may be implemented, at least in part, or in modified form, by a processor of another remote computer or a local circuit, such as for example, the client module 130 in the client computing device 106(1). In addition, one or more of the operations of the routines 600, 700 and/or 800 may alternatively or additionally be implemented, at least in part, by a chipset working alone or in conjunction with other software modules. Any service, circuit or application suitable for providing the techniques disclosed herein can be used in operations described herein.

Although the techniques described herein have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context presented that certain examples include, while other examples do not include, certain features, elements and/or steps. Thus, such conditional language is not generally intended to imply that certain features, elements and/or steps are in any way required for one or more examples, or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method in a communication system comprising:
capturing, at a computing device, an image from a user of an application;
determining an expression from the image;
identifying a graphical expression which corresponds to the emotion;
displaying the graphical expression; and
sending the graphical expression from the computing device to a remote computing device.

2. The method of claim 1, further comprising providing a keyboard service integrated into the application for displaying the graphical expression within the keyboard service, and wherein the keyboard service is configured to receive a selection of the graphical expression, and wherein sending the graphical expression is in response to the selection.

3. The method of claim 1, further comprising analyzing text messages communicated from the computing device, wherein the analysis of the text is used in the identification of the graphical expression.

4. A method, comprising:
receiving one or more streams associated with a communication session, the one or more streams comprising image data of a user participating in the communication session;
analyzing at least one physical feature of the user to determine a category of expressions;
selecting a graphical expression from a plurality of graphical expressions, wherein the selection of the graphical expression is based on the category of expressions;
causing a display of a graphical user interface on a client computing device associated with one or more users in communication with the user, wherein the graphical user interface includes a rendering of the graphical expression.

5. The method of claim 1, wherein the step of displaying further comprises:
providing a first area of a screen for a plurality of the graphical expressions associated with the emotion.

6. The method of claim 5, further comprising a second area of the screen for a keyboard, wherein the first area and the second area are controlled by a single application.

7. The method of claim 5, further comprising a second area of the screen for a keyboard, wherein the first area and the second area are controlled by first and second separate applications.

8. A method, comprising:
receiving one or more streams associated with a communication session, the one or more streams comprising image data of a user participating in the communication session;
analyzing at least one physical feature of the user to determine a category of expressions;
providing in a first input area a plurality of graphical expression from based on the category of expressions;
determining when a selection of one of the plurality of graphical expressions has occurred in the first input area;
causing a display to render the selected one of the plurality of graphical expressions, the display being on a client computing device associated with one or more users in communication with the user.

9. A method for improving user interaction of a computing device, comprising:
receiving image data depicting a user interacting within a communication session between the computing device and at least one remote device;
analyzing one or more one physical features of the user depicted in the image data to select an expression representative of the user, wherein the expression is selected based on a shape of the one or more one physical features of the user;
selecting a subset of graphical expressions from a list of graphical expressions, wherein the subset of graphical expressions is selected based on the expression representative of the user, wherein the subset of graphical expressions filters the list of graphical expressions displayed to the user, wherein a display screen of the computing device shows the subset of graphical expressions that are representative of the user;
receiving a user selection of a single graphical expression from the subset of graphical expressions; and
in response to the user selection, communicating data defining the single graphical expression to the remote device for display of the single graphical expression on a display screen of the remote device.

10. The method of claim 9, further comprising analyzing text messages communicated from the user, wherein the analysis of the text is used in the selection of the subset of graphical expressions.

11. The method of claim 9, wherein the data defining the graphical expression comprises an image of an avatar depicting a smile when the one or more one physical features indicates that the user is smiling.

12. The method of claim 9, further comprising:
causing the computing device to display a set of graphical expressions from the list of graphical expressions; and
causing the computing device to display at least a portion of the subset of graphical expressions.

13. The method of claim 12, wherein the set of graphical expressions and the portion of the subset of graphical expressions are displayed by a software component that provides a keyboard service, wherein the keyboard service overlays a display of a keyboard in conjunction with a text entry field of the operating system or at least one text entry field of a third-party application.

14. The method of claim 9, further comprising:
storing image data in a memory device; and
causing one or more computing devices to analyze the stored image data using one or more machine learning techniques to improve future selections of the subset of graphical expressions from the list of graphical expressions.

15. The method of claim 14, further comprising:
storing text messages communicated from the user; and
causing one or more computing devices to analyze the text messages and the user selection using the one or more machine learning techniques to improve future selections of the subset of graphical expressions from the list of graphical expressions.

16. A system comprising:
one or more processing units; and
a computer-readable medium having encoded thereon computer-executable instructions to cause the one or more processing units to execute a method comprising
receiving image data depicting a user interacting within a communication session between the computing device and at least one remote device;
analyzing one or more one physical features of the user depicted in the image data to select an emotion notification representative of an emotional state of the user, wherein the emotion notification is selected based on a shape of the one or more one physical features of the user;
selecting the emotion notification; and
communicating the emotion notification to the remote device for display on a display screen of the remote device.

17. The system of claim 16, wherein the emotion notification represents a sad, emotional state when the one or more one physical features indicates that the user is frowning.

18. The system of claim 16, wherein the method further comprises:
causing the computing device to display the emotion notification; and
in response to a user selection of the display of the emotion notification, communicating the emotion notification to the remote device for display of the emotion notification on a display screen of the remote device.

19. The system of claim 18, wherein the emotion notification is displayed by a software component that provides a keyboard service, wherein the keyboard service overlays a display of a keyboard in conjunction with a text entry field of the operating system or at least one text entry field of a third-party application.

20. The system of claim 16, wherein the method further comprises:
storing image data in a memory device; and
causing one or more computing devices to analyze the stored image data using one or more machine learning techniques to improve future selections of the emotion notification.

21. The system of claim 20, wherein the method further comprises:
storing text messages communicated from the user; and
causing one or more computing devices to analyze the text messages and the user selection using the one or more machine learning techniques to improve future selections of the emotion notifications.

22. A method comprising:
receiving one or more streams associated with a communication session, the one or more streams comprising image data of a user participating in the communication session;
analyzing one or more one physical features of the user depicted in the image data to select an expression representative of the user, wherein the expression is selected based on a shape of the one or more one physical features of the user;
selecting a subset of graphical expressions from a list of graphical expressions, wherein the subset of graphical expressions is selected based on the expression representative of the user, wherein the subset of graphical expressions filters the list of graphical expressions displayed to the user, wherein a display screen of the computing device shows the subset of graphical expressions that are representative of the user;
receiving a user selection of a single graphical expression from the subset of graphical expressions; and
in response to the user selection, communicating data defining the single graphical expression to the remote device for display of the single graphical expression on a display screen of the remote device.

23. The method of claim 22, further comprising analyzing text messages communicated from the user, wherein the analysis of the text is used in the selection of the subset of graphical expressions.

24. The method of claim 22, wherein the data defining the graphical expression comprises an image of an avatar depicting at least one of a smile or a frown.

25. The method of claim 22, further comprising:
causing the computing device to display a set of graphical expressions from the list of graphical expressions; and
causing the computing device to display at least a portion of the subset of graphical expressions.

26. The method of claim 25, wherein the set of graphical expressions and the portion of the subset of graphical expressions are displayed by a software component that provides a keyboard service, wherein the keyboard service overlays a display of a keyboard in conjunction with a text entry field of the operating system or at least one text entry field of a third-party application.

27. The method of claim 22, further comprising:
storing image data in a memory device; and
causing one or more computing devices to analyze the stored image data using one or more machine learning techniques to improve future selections of the subset of graphical expressions from the list of graphical expressions.

28. The method of claim 8, further comprising analyzing text messages communicated from the user, wherein the analysis of the text is used in the selection of the subset of graphical expressions.

29. The method of claim 8, wherein data defining the selected one of the plurality of graphical expressions comprises an image of an avatar depicting a smile when the at least one physical feature of the user indicates that the user is smiling.
